(19) United States
(12) Patent Application Publication
(10) Pub. No.: US 2006/0272205 A1
(43) Pub. Date: Dec. 7, 2006

(54) Time-release, oxygen-generating, and effervescing nutrient compositions and methods for growing plants

(75) Inventors: W. Michael Bissonnette, Boulder, CO (US); John Thompson, Boulder, CO (US); Robert E. Wainwright, Longmont, CO (US); Sylvia Bernstein, Boulder, CO (US); Laura L. Conley, Boulder, CO (US)

Correspondence Address: AeroGrow International, Inc., Suite #201, 900 28th St., Boulder, CO, 80303, US

(73) Assignee: AeroGrow International, Inc., Boulder, CO (US)

(21) Appl. No.: 11/321,910

(22) Filed: Dec. 28, 2005

Related U.S. Application Data
(60) Provisional application No. 60/640,606, filed on Dec. 30, 2004.

(51) Int. Cl. A01C 21/00

(52) U.S. Cl. 47/57.6

(57) ABSTRACT

This invention provides time-release plant nutrient compositions, oxygen-generating nutrient compositions, and effervescing nutrient compositions, in the forms of powders, capsules, tablets, pellets, and granules. The oxygen-generating agents include peroxides, percarboxylics, percarbonates, and mixtures thereof. This invention provides methods for making the compositions of this invention and methods for fertilizing a plant or a seed and/or providing oxygen to a plant or seed growing in a hydroponics system.

### CROSS-REFERENCE TO RELATED APPLICATIONS

This application claims priority under 35 U.S.C. 119(e) to provisional patent application 60/640,606, filed Dec. 30, 2004, which is hereby incorporated by reference in its entirety to the extent not inconsistent with the disclosure herein.

### FIELD OF THE INVENTION

This invention is in the fields of plant agriculture, home gardening, indoor gardening, and hydroponics.

### BACKGROUND

Plants require appropriate amounts of water, nutrients, photoradiation, carbon dioxide, and oxygen. Water, nutrients, and oxygen are acquired by plants through their roots.

When plants are grown in soil, oxygen is supplied to the roots from the air spaces in the soil and from the dissolved oxygen in water added to the soil. Plant roots can form specialized structures called air roots to obtain oxygen from air. When soils become water-logged, the water replaces the air in the soil, and because the plants can no longer use the air roots to obtain oxygen, the plants can drown. Also, stagnant water, such as water in water-logged soil, tends to have low amounts of dissolved oxygen.

It is known in the art that dissolved oxygen is the amount of oxygen gas dissolved in a given quantity of water at a given temperature and atmospheric pressure. It is usually expressed as a concentration in parts per million or as a percentage of saturation. It is known in the art that a maximum amount of dissolved oxygen can be present in water at each selected temperature and pressure (http://www.coff.edu/ete/modules/waterq3NVQassess3f.html).

Hydroponics is the cultivation of plants without soil. Hydroponics provides healthier, disease-free plants, faster than growing in soil. In soil-less culture, plants are instead cultivated using a liquid solution of water and nutrients. There are 6 basic types of hydroponic systems: Wick, Raft (also called Water Culture), Ebb and Flow (also called Flood & Drain), Drip, Nutrient Film Technique, and Aeroponic. There are hundreds of variations on these basic types of systems, and most hydroponics systems can be described as a variation or combination of these six types. When plants are grown hydroponically, the oxygen is supplied in the water and/or in the air in which the roots are suspended.

A variety of methods exist for increasing the concentration of dissolved oxygen in water. For example, oxygen gas, or a gas containing more oxygen than is found in the water, can be bubbled or stirred into the water, as in a fish bubbler or a waterfall. US 2003/0213170 describes aerohydroponic circulation by providing an air tube to carry outside air into the nutrient solution.

Alternatively, chemicals that generate oxygen can be added to the water. Hydrogen peroxide solution has been used to generate oxygen. Chemicals that generate oxygen are used in oxygen bleach cleaning products, dental hygiene products, and in products for keeping fish bait alive longer [O-Tabs (Pemble-Halverson, Inc., River Falls, Wis. USA) which contain calcium phosphate, strontium peroxide, calcium sulfate, and manganese dioxide, Bait Buddies and Aqua Lung which appear to be similar products, and Jungle Bag Buddies]. JP 62269624 describes a hydroponic culture apparatus having a device for generating oxygen by supplying hydrogen peroxide solution to manganese dioxide.

Peroxides are antiseptic and have also been used to clean hydroponic systems. U.S. Pat. No. 5,168,655 describes hydroponic crop production including a disinfection step prior to a crop production cycle, said step using a dilute aqueous solution containing hydrogen peroxide and at least one peracid, —COO—OH, a percarboxylic acid. U.S. Pat. No. 6,295,759, assigned to Solvay, describes a process for hydroponic cultivation of plants including a step of adding a disinfectant, such as percarboxylic acid, to the irrigation solution. (20 mg/L to 200 mg/L)

Chemicals that generate oxygen can also be added to soil for improved growth or bioremediation. Solvay Chemicals (Houston, Tex. USA) sells IXPER® calcium peroxide and magnesium peroxide as sources of oxygen in agricultural and horticultural applications. Shangyuchem sells sodium percarbonate, zinc peroxide, calcium peroxide, magnesium peroxide, TAED, sodium perborate, and potassium monopersulfate as oxygen releasing chemicals for agricultural applications. FMC corporation (Philadelphia, Pa. USA) sells PermeOx® Plus, a calcium peroxide, as an oxygen source for bioremediation. JP 03158303 describes combining hydrogen peroxide with fertilizer salts and an inorganic acid and regulating its pH to about 2 to 4 for supplying oxygen to the rhizosphere of crops. The rhizosphere is the area around the plant root zone in which the roots interact with soil microbes.

When plants are grown hydroponically, the nutrients are supplied to the plant dissolved in the water. In hydroponics, nutrients have been supplied in liquid and powder forms that immediately and completely dissolve. Nutrients are often provided as “grow” and “bloom” formulas for different stages of plant growth.

Plant nutrients are known in the art to include macronutrients and micronutrients. Plants require available nutrients in known concentrations that vary for each species and at different stages of maturity. Plant nutrients include calcium, magnesium, sodium, potassium, nitrogen, phosphorus, sulfur, chlorine, iron, manganese, copper, zinc, boron, and molybdenum. Plants growing in soil absorb nutrients from the soil. Microbes in the soil can help make some nutrients more available to the plants. Many fertilizers are available for supplementing the nutrients found in soils.

Fertilizers that are applied to soils can easily be washed away and can contaminate the water supply. For environmental, economic, and ease-of-use reasons, fertilizers and nutrients are available in slow-release and time-release forms. Timed-release nutrient formulations are available in the art for use as soil supplements and in potting mixes for home gardening and for agricultural production. Formulations currently available are divisible into four categories: products having timed-release coatings on soluble fertilizers, products in which a fertilizer compound is slowly dissolved by soil microbes, physically compressed fertilizer compounds optionally mixed with insoluble ingredients that undergo slow physical dissolution and products having fertilizer compounds that undergo slow chemical dissolution.

A variety of products having timed-release coatings on soluble fertilizers are available on the market. Typically, fertilizer salts that are all highly water soluble and compatible with each other in mixture are granulated and then coated, e.g., with a number of synthetic resins to provide a porous structure coating for the granule. The porous coating allows the entry of water from the soil, the dissolution of fertilizer within the granule, and the release of nutrient ions back through the coating and into the surrounding soil. The timed-release pattern is adjusted by using various thicknesses of various resin compounds and combinations, to produce different levels of porosity. Examples include Scotts Osmocote® (Osmocote, Marysville, Ohio, USA) and Nutricote (Brampton, ON, CA). These types of products are typically pH or temperature dependent. Fertilizers having timed-release coatings have not been able to provide adequate levels of calcium and phosphate because calcium and phosphate have been incompatible with the other fertilizer salts in the granules. Often calcium superphosphate, lime (calcium carbonate), and/or another phosphate must be used in conjunction with these products. The nitrogen component utilized in these products is often ammonia.

A variety of fertilizer products are synthesized to dissolve slowly by the action of microbes and to release nutrient ions in the process. Many products are made with urea-formaldehyde or IBDU® (Isobutylidene diurea), which are used to prevent the otherwise rapid leaching or volatilization of nitrogen from soil after nitrogen application. The composition of the product is adjusted to produce slower or faster rates of nitrogen leaching or disintegration. These products can also be made with Gypsum, calcium sulfate, and/or gelatinizing agents. When fertilizers are combined with these materials they become incorporated into a porous and/or gelatinous structure. The various compositions of the resulting porous gelatinous materials provide various release rates. Examples include Jobe's plant spikes (Home Harvest® Garden Supply, Inc., Baltimore, Md., USA), Grotek (Langley, B.C. Canada) Plant Pills for plants potted in soil, and aquarium fish feeding tablets (e.g., Wardley® Premium Weekend Feeder™, The Hartz Mountain Corporation, Secaucus, N.J., USA) and pond plant tablets [Pond Cares Aquatic Plant Food Tablets from Aquarium Pharmaceuticals E.C., Inc (Oxford, Oxfordshire, Great Britain), Throw-Tabs and Aquatic-Tabs by AgSafe® and Generic Pond Tablets and Spikes by Gardenlink, all from AgriTab (Clearfield, Utah USA)]. Micracl®-Gro Instant Action™ Houseplant Food Tablets (Scotts Miracle-Gro Products, Inc. Marysville, Ohio, USA) effervesce, a reaction of acid and carbonate, to produce carbon dioxide gas when dissolved in water. There are no products in this category available on the market that contain a full range of nutrients, suitable for growing plants without soil.

The third category includes fertilizer products in molecular forms that are very slowly soluble in soil, including insoluble hydroxides of trace elements and rock phosphate. These products require selected pH environments and/or microbial action for the nutrients to become available to plants.

There is no known product currently available on the market that supplies the full spectrum of nutrient ions, in the correct balance, which can be released at an appropriate rate, and that dissolves sufficiently completely into solution for use in hydroponics. All products known in the art do not release a complete range of nutrient ions and their use in hydroponics results in nutrient deficiencies, they require additional fertilizers, they result in phytotoxicity, and/or do not release nutrient ions fast enough to be used in a hydroponic environment.

JP 04126939 describes a mixture of inorganic peroxide, a neutralizer, and a solidifying agent that is mixed with a plant nutrient and press molded into a prescribed shape to improve plant growth by supplying oxygen to soil. The products of JP 04126939 do not contain all the nutrients required for growing plants hydroponically, they contain an unnecessary neutralizing ingredient, and they are not time-release.

No known plant nutrient products are currently available on the market which release nutrients in a time-release manner and generate oxygen.

### SUMMARY OF THE INVENTION

This invention provides a time-release plant nutrient composition comprising a complete set of plant nutrient ingredients and at least one time-release agent. In an embodiment, the time-release plant nutrient composition has been compressed into a tablet, pellet, or granule. In an embodiment, the time-release plant nutrient composition further comprises an oxygen-generating agent and/or a pair of effervescing agents.

This invention provides an oxygen-generating plant nutrient composition comprising: at least one oxygen-generating agent and at least one plant nutrient ingredient. In an embodiment, the oxygen-generating agent is selected from the group consisting of peroxides, percarboxylics, percarbonates, and mixtures thereof. In an embodiment, the oxygen-generating plant nutrient composition is useful for growing plants hydroponically. In an embodiment, the oxygen-generating plant nutrient composition comprises a complete set of plant nutrients. In an embodiment, the oxygen-generating plant nutrient composition further comprises a time-release agent and/or a pair of effervescing agents.

This invention provides a method for providing oxygen to a plant growing or a seed germinating in a hydroponics system containing an aqueous liquid, said method comprising adding an oxygen-generating plant nutrient composition of this invention to said aqueous liquid.

This invention provides an effervescing plant nutrient composition comprising a complete set of plant nutrient ingredients and at least one pair of effervescing agents. In an embodiment, the pair of effervescing agents comprises an acid and a carbonate. In an embodiment, the effervescing plant nutrient composition further comprises a time-release agent and/or an oxygen-generating agent.

This invention provides a method for providing a complete set of plant nutrients to a plant growing or a seed germinating in a hydroponics system containing an aqueous liquid, said method comprising adding a time-release plant nutrient composition of this invention to said aqueous liquid.

This invention provides a method for providing oxygen to a plant growing or a seed germinating in a hydroponics system containing an aqueous liquid, said method comprising adding a oxygen-generating plant nutrient composition of this invention to said aqueous liquid.

### DETAILED DESCRIPTION OF THE INVENTION

As used in the art and as used herein, “nutrients” refers to atoms and molecules in an available form necessary for plant growth in addition to oxygen, hydrogen, and water including, but not limited to, calcium, magnesium, sodium, potassium, nitrogen, phosphorus, sulfur, chlorine, iron, manganese, copper, zinc, boron, and molybdenum. Nutrient formulations and recipes are known in the art (see, for example, Resh H. M (2001) Hydroponic Food Production, Sixth Addition, Woodbridge Press Publishing Company, Santa Barbara, Calif., USA). As used in the art and as used herein, “grow” and “bloom” nutrients are complete sets of nutrients for vegetative and blooming/fruiting stages of plant development. Bloom nutrients are also useful for plants growing better with more nitrogen, magnesium, sulfate, and calcium, such as herbs, particularly basil.

It is known in the art that a liquid that contacts a plant, e.g., liquid used to supply nutrients to a plant, is preferably within a particular pH range. Optimal pH ranges for a variety of plants are known in the art. Preferably the compositions and methods of this invention maintain the pH of liquids within the optimal pH ranges.

As used herein, “photoradiation” refers to wavelengths of light of sufficient quantity and quality that allow a plant to grow, as is known in the art. It is known in the art which quantities and wavelengths of photoradiation are preferred for many plants.

As used herein, “time-release” refers to releasing over a time period longer than about instantly. “Timed-release” is another term used in the art for time-release.

As used herein, “generate oxygen” refers to generating by a chemical means, whereas, “introducing oxygen” refers to introducing by a mechanical or other non-chemical means. Oxygen includes, but is not limited to, oxygen gas, such as can dissolve in a liquid and become available to a plant.

This invention provides a time-release plant nutrient composition comprising a complete set of plant nutrient ingredients and at least one time-release agent. In an embodiment, the time-release plant nutrient composition has been compressed into a tablet, pellet, or granule. In an embodiment, the time-release plant nutrient composition further comprises an oxygen-generating agent and/or a pair of effervescing agents.

This invention provides an oxygen-generating plant nutrient composition comprising: at least one oxygen-generating agent and at least one plant nutrient ingredient. In an embodiment, the oxygen-generating agent is selected from the group consisting of peroxides, percarboxylics, percarbonates, and mixtures thereof. In an embodiment, the peroxide is not hydrogen peroxide. In an embodiment, the peroxide is selected from the group consisting of: sodium peroxide, potassium peroxide, magnesium peroxide, calcium peroxide, strontium peroxide, and mixtures thereof. In an embodiment, the percarbonate is selected from the group consisting of sodium percarbonate, potassium percarbonate, and mixtures thereof. In an embodiment, the oxygen-generating agent is in an amount selected from the group consisting of: less than about 10% by weight, less than about 5% by weight, less than about 2% by weight, less then amount 1% by weight, and less than 0.5% by weight. In an embodiment, the oxygen-generating plant nutrient composition is useful for growing plants hydroponically. In an embodiment, the oxygen-generating plant nutrient composition comprises a complete set of plant nutrients. In an embodiment, the oxygen-generating plant nutrient composition further comprises a time-release agent and/or a pair of effervescing agents.

This invention provides a method for providing oxygen to a plant growing or a seed germinating in a hydroponics system containing an aqueous liquid, said method comprising adding an oxygen-generating plant nutrient composition of this invention to said aqueous liquid.

This invention provides an effervescing plant nutrient composition comprising a complete set of plant nutrient ingredients and at least one pair of effervescing agents. In an embodiment, the pair of effervescing agents comprises an acid and a carbonate. In an embodiment, the acid is citric acid and said carbonate is selected from the group consisting of: sodium bicarbonate, sodium carbonate, potassium bicarbonate, potassium carbonate, and mixtures thereof. In an embodiment, the effervescing plant nutrient composition further comprises a time-release agent and/or an oxygen-generating agent.

This invention provides a method for providing a complete set of plant nutrients to a plant growing or a seed germinating in a hydroponics system containing an aqueous liquid, said method comprising adding a time-release plant nutrient composition of this invention to said aqueous liquid.

This invention provides a method for providing oxygen to a plant growing or a seed germinating in a hydroponics system containing an aqueous liquid, said method comprising adding a oxygen-generating plant nutrient composition of this invention to said aqueous liquid.

This invention provides time-release plant nutrient composition comprising: at least one plant nutrient ingredient and at least one time-release agent. This invention provides time-release oxygen-generating compositions for hydroponics comprising: at least one oxygen-generating agent and at least one time-release agent.

In an embodiment, the time-release plant nutrient composition comprises a complete set of plant nutrient ingredients. In an embodiment, the plant nutrient ingredient is calcium nitrate or magnesium sulfate.

In an embodiment, the time-release plant nutrient composition is for growing plants hydroponically.

In an embodiment, the time-release agent is a capsule for containing the plant nutrient. In an embodiment, the capsule is a vegetarian capsule. In an embodiment, the time-release agent is a binding agent. In an embodiment, the time-release composition has been compressed into a tablet, pellet, or granule.

In an embodiment, when the time-release plant nutrient composition is placed in a liquid, the at least one plant nutrient is released about completely during a time period selected from the group consisting of: between about 1 minute and about 1 month, between about 5 minutes and about 2 weeks, between about 1 week and about half an hour, between about 1 hour and about 48 hours, between about 2 hours and about 1 day, about 1 minute, about 5 minutes, about half an hour, about 1 hour, about 2 hours, about 6 hours, about 12 hours, about 24 hours, about 48 hours, about 1 week, and about 2 weeks. In an embodiment, the composition about completely dissolves in the liquid during the time period.

In an embodiment, the composition also comprises a set of effervescing agents. In an embodiment, the set of effervescing agents comprises an acid and a carbonate. In an embodiment, the acid is citric acid and the carbonate is selected from the group consisting of: sodium bicarbonate, sodium carbonate, potassium bicarbonate, potassium carbonate, and mixtures thereof.

In an embodiment, the time-release plant nutrient composition also comprises an oxygen-generating agent. In an embodiment, the oxygen-generating agent is in an amount selected from the group consisting of: less than about 10% by weight, less than about 5% by weight, less than about 2% by weight, less then amount 1% by weight, and less than 0.5% by weight.

This invention provides methods for fertilizing a plant growing in a hydroponics system comprising a liquid, the methods comprising adding the time-release plant nutrient composition to the liquid.

This invention provides methods for growing a plant in a hydroponics system comprising a liquid, the method comprising adding a time-release plant nutrient of this invention to the liquid before the first and then after every time period selected from the group consisting of: about 1 week, about 2 weeks, about 1 month, while the plant is growing.

This invention provides methods for making a time-release nutrient composition of this invention comprising combining the at least one plant nutrient ingredient and the at least one time-release agent. In an embodiment, the time-release agent is a capsule and the method comprises filling the capsule with the plant nutrient ingredient. In an embodiment, the time-release agent is a binding agent and the method comprises mixing the plant nutrient ingredient and the binding agent and compressing the mixture into a tablet, pellet, or granule.

In an embodiment, the oxygen-generating agent is selected from the group consisting of peroxides, percarboxylics, percarbonates, and mixtures thereof. In an embodiment, the peroxide is not hydrogen peroxide. In an embodiment, the peroxide is a powder at ambient temperature and pressure. In an embodiment, the peroxide is selected from the group consisting of: sodium peroxide, potassium peroxide, magnesium peroxide, calcium peroxide, strontium peroxide, and mixtures thereof. In an embodiment, percarbonate is selected from the group consisting of sodium percarbonate, potassium percarbonate, and mixtures thereof.

In an embodiment, the time-release oxygen-generating composition for hydroponics is placed in an aqueous solution useful in a hydroponics system, the at least one plant nutrient is released about completely during a time period selected from the group consisting of: between about 1 minute and about 1 month, between about 5 minutes and about 2 weeks, between about 1 week and about half an hour, between about 1 hour and about 48 hours, between about 2 hours and about 1 day, about 1 minute, about 5 minutes, about half an hour, about 1 hour, about 2 hours, about 6 hours, about 12 hours, about 24 hours, about 48 hours, about 1 week, and about 2 weeks. In an embodiment, the composition about completely dissolves in the aqueous solution during the time period.

In an embodiment, the time-release oxygen-generating composition for hydroponics also comprises at least one plant nutrient ingredient. In an embodiment, the time-release oxygen-generating composition for hydroponics comprises a complete set of plant nutrient ingredients.

In an embodiment, the time-release oxygen-generating composition for hydroponics comprises an oxygen-generating agent is in an amount selected from the group consisting of: less than about 10% by weight, less than about 5% by weight, less than about 2% by weight, less then amount 1% by weight, and less than about 0.5% by weight.

This invention provides methods for providing oxygen to a plant growing in a hydroponics system comprising an aqueous liquid, the method comprising adding the time-release oxygen-generating composition for hydroponics of this invention to the aqueous liquid.

This invention provides methods for growing a plant in a hydroponics system comprising an aqueous liquid, the method comprising adding the time-release oxygen-generating composition for hydroponics of this invention to the aqueous liquid before the first time and then after every time period selected from the group consisting of: about 1 week, about 2 weeks, about 1 month, while the plant is growing. In an embodiment, the oxygen-generating agent is less than about 20 mg/L in the aqueous liquid.

This invention provides methods for making time-release oxygen-generating compositions for hydroponics comprising combining at least one oxygen-generating agent and at least one time-release agent. In an embodiment, the time-release agent is a capsule and the method comprises filling the capsule with the oxygen-generating agent.

In an embodiment, the time-release agent is a binding agent and the method comprises mixing the oxygen-generating agent and the binding agent and compressing the mixture into a tablet, pellet, or granule.

This invention provides time-release, oxygen-generating plant nutrient compositions comprising at least one plant nutrient ingredient, at least one oxygen generating agent, and at least one time-release agent.

In an embodiment, the time-release, oxygen-generating plant nutrient composition comprises a complete set of plant nutrient ingredients. In an embodiment, the time-release, oxygen-generating plant nutrient composition is for growing plants hydroponically. In an embodiment, the time-release, oxygen-generating plant nutrient composition also comprises a set of effervescing agents.

This invention provides a plurality of time-release, oxygen-generating plant nutrient compositions that comprise a complete set of plant nutrients. In an embodiment, the plurality of time-release, oxygen-generating plant nutrient compositions comprise a time-release, oxygen-generating plant grow nutrient composition, a time-release, oxygen-generating plant calcium nitrate composition, and a time-release, oxygen-generating plant magnesium sulfate composition.

In an embodiment, the plurality of time-release, oxygen-generating plant nutrient compositions is a time-release, oxygen-generating plant bloom nutrient composition.

This invention provides methods for delivering nutrients and oxygen to a plant growing or a seed germinating in a hydroponics system comprising an aqueous liquid, the method comprising: providing a time-release, oxygen-generating plant nutrient composition comprising at least one plant nutrient, at least one oxygen generating agent, and at least one time-release agent; and adding the time-release, oxygen-generating plant nutrient composition to the aqueous liquid.

This invention provides methods for making a time-release, oxygen-generating plant nutrient composition comprising: providing an oxygen-generating agent; providing a plant nutrient ingredient; providing a time-release agent; and combining the oxygen-generating agent, the plant nutrient ingredient, and the at least one time-release agent.

In an embodiment, the time-release agent is a capsule and the method comprises filling the capsule with the oxygen-generating agent and the plant nutrient ingredient. In an embodiment, the time-release agent is a binding agent and the method comprises: combining the oxygen-generating agent, the plant nutrient ingredient, and the binding agent, and compressing the mixture into a tablet or pellet.

This invention provides a set of time-release compositions useful for providing all the nutrients required for the lifetime of a plant.

In an embodiment, the time-release compositions of this invention are formulated or provided as capsules, tablets, pellets, and/or granules. All capsules known in the art are useful in the practice of this invention, however vegetarian capsules are preferred.

In an embodiment, the set of effervescent agents includes an acid and a carbonate base. Acids useful in the practice of this invention include, but are not limited to, citric acid, tartaric acid, malic acid, fumaric acid, adipic acid, acid citrates, succinic acid and mixtures thereof. Carbonate bases useful in the practice of this invention include, but are not limited to, sodium carbonate, potassium carbonate, sodium bicarbonate, potassium bicarbonate, calcium bicarbonate, magnesium carbonate, sodium glycocarbonate, carboxylysine and mixtures thereof.

Binding agents useful in the practice of this invention include, but are not limited to, polymers, sorbitol, lactose, maltodextrin, dextrin, xylitol, and mixtures thereof. All binding agents that do not interfere in plant growth and/or hydroponics system function are useful in the practice of this invention.

This invention provides compositions that include ingredients useful for growing plants and preferably do not contain ingredients that are toxic to plants (agrotoxins) such as heavy metals including, but not limited to, lead, cadmium, and mercury. Preferably, the compositions of this invention do not contain too much of ingredients that are toxic in high amounts, such as sodium, sulfates, boron, etc. Different plants can tolerate different levels of agrotoxins. The levels of agrotoxins that are toxic to many plants are known in the art.

In an embodiment, the time-release compositions of this invention disintegrate and/or dissolve sufficiently for use in pumping and/or spraying hydroponics systems. In an embodiment, the time-release compositions of this invention are 100% soluble in room temperature water.

In an embodiment, the compositions of this invention also comprise one or more excipients, including, but not limited to, fillers, binding agents, lubricating agents, mold-releasing agents, disintegration rate control agents, surfactants, solubility control agents, anti-redeposition agents, coloring agents, fragrances, corrosion inhibitors, disinfectants, and pesticides.

In an embodiment, the tablet and pellet compositions of this invention are of a low hardness for ease of production and faster disintegration rate, are of a high stability to prevent decomposition of active ingredients or crumbling, and contain zero or a substantially small percentage of insoluble disintegrants or other ingredients.

The time-release compositions of this invention are manufactured using convenient and economical production methods and packaged in convenient and economical packaging.

In an embodiment, the oxygen-generating agents in the compositions of this invention, when dissolved in a hydroponics system, are at a sufficiently low concentration to not be substantially toxic to a plant grown in the system, but may be at a sufficiently high concentration to be toxic to unwanted organisms in the hydroponics system such as algae or microorganisms. All oxygen-generating agents know in the art that do not substantially interfere with plant growth are useful in the practice of this invention. Oxygen-generating agents useful in the practice of this invention include, but are not limited to, peroxides, percarboxylics, percarbonates, and mixtures thereof.

The time-release compositions of this invention comprise one or more ingredients to be released in a time-dependent manner at a selected release rate. In an embodiment of this invention the selected release rate is about constant or variable. In an embodiment of this invention, the release rate is variable and changes periodically. A release rate of each composition is selected for its intended application.

When the time-release compositions of this invention are used in a non-circulating hydroponics system, the dissolving composition may require stirring. The time-release compositions of this invention that comprise a set of effervescing agents do not require stirring in non-circulating hydroponics systems.

In an embodiment, the plant nutrients are in an available form in the proportions listed in Table 1.

TABLE 1

| Atom | Percent |
|---|---|
| nitrogen | 10 |
| phosphorus | 8 |
| potassium | 22 |
| calcium | 5 |
| iron | 0.2 |
| manganese | 0.1 |
| zinc | 0.01 |
| copper | 0.01 |
| boron | 0.02 |
| molybdenum | 0.005 |

In an embodiment, the at least one plant nutrient is a complete set of nutrients such as Hobby Formula (Hydro-Gardens, Colorado Springs, Colo. USA). In an embodiment, for a grow nutrient, 2.34 g are added per gallon of water for use in a hydroponics system. In an embodiment for a bloom nutrient, 2.34 g Hobby is added, 0.75 g of Calcium Nitrate, and 1 g of Magnesium Sulfate are added per gallon of water. These grow and bloom formulas are for two weeks of growth.

Ingredients useful for making plant nutrients are known in the art and include, but are not limited to: Boric Acid, Calcium Chloride, Calcium Nitrate, Di-Ammonium Phosphate, Magnesium Sulfate, Mono-Ammonium Phosphate, Mono-Potassium Phosphate, Potassium Chloride, Potassium Sulfate, Copper Sulfate, Iron Sulfate, Manganese Sulfate, Zinc Sulfate, Magnesium Sulfate, Calcium Nitrate, Calcium Chelate, Copper Chelate, Iron Chelate, Iron Chelate, Manganese Chelate, Zinc Chelate, and Ammonium Molybdate.

In an embodiment, the plant nutrient is calcium nitrate. In an embodiment, the plant nutrient is magnesium sulfate, in a form that is about 9.9% magnesium. A composition containing all the items listed in Table 1 is an example of a complete set of plant nutrients.

All hydroponics systems known to the art or as yet to be invented are useful in the practice of this invention. The compositions and methods of this invention are useful in an enclosed hydroponics system.

Methods are known in the art for making tablets, pellets, and granules. Useful tablet press equipment includes, but is not limited to, manual, hydraulic, and rotary presses. Formulations for making tablets are known in the art. Preferably excipients are selected that do not substantially interfere with plant growth.

In an embodiment, the time-release composition is packaged for a selected hydroponics system for growing a selected plant variety, whereby the precise amount of active ingredients is included for a selected time period when growing the selected variety in the selected hydroponics system, thereby requiring addition of only one package or one set of packages per time period. Active ingredients can include, but are not limited to, plant nutrients, effervescent agents, oxygenating agents, and/or time-release agents. For example, one package with grow nutrients suitable for seedlings of most crops or lettuce, could include plant nutrients and oxygenating agent that are released in one hour and sufficient for two weeks of growth. As another example, one set of packages for bloom nutrients suitable for herbs and flowering tomatoes, could include, in a first package, plant nutrients and oxygenating agent that are release in one hour, and in a second package, calcium nitrate that is released in one hour, and in a third package, magnesium sulfate that is released in one hour, together suitable for two weeks of growth.

In an embodiment, methods of making the compositions of this invention include a step of thoroughly mixing all ingredients before combining in a time-release form.

In an embodiment, the compositions of this invention are useful for growing lettuces, tomatoes, herbs, and flowers.

The compositions and methods of this invention are useful for growing plants from seed through maturity.

In an embodiment, the compositions of this invention are useful without ever needing to come into contact with soil.

The embodiments of this invention are useful with both the compositions and methods of this invention.

Appropriate nutrient formulations and concentrations for selected plants and plant developmental stages are known in the art.

In an embodiment, a composition or a set of compositions of this invention, are packaged for one dose per time period, e.g. one dose per week. This invention provides sets of such time period packaged compositions, wherein such sets are useful for the complete lifetime of a plant grown using the methods of this invention. In an embodiment, no other nutrients need to be added during the lifetime of the plant.

The time-released nutrient compositions of this invention provide a more consistent supply of nutrients over a time period than non-time-released compositions. Also, since many seeds germinate at a higher percentage and more vigorously without or with low concentrations of nutrients, if a nutrient is to be added to a hydroponic garden when the seeds are first started, a time-release nutrient that does not dissolve about immediately provides for a higher germination rate and more vigorous plants compared to using a full-strength nutrient that dissolves immediately.

The oxygen-generating nutrient compositions of this invention provide oxygen to growing roots, providing more vigorous plants and faster and more shoot growth for plants in hydroponics systems or in soil (that are watered with an aqueous solution containing the oxygen-generating compositions of this invention) compared to using nutrient compositions without oxygen-generating agents of this-invention. When the oxygen-generating nutrient compositions of this invention are added to an aqueous liquid, they chemically react to generating oxygen gas, some of which dissolves in the liquid, thereby increasing the dissolved oxygen content of the liquid. The dissolved oxygen is then available to plant roots contacted by the liquid.

The effervescing nutrient compositions of this invention provide carbon dioxide to growing plant shoots and leaves. The carbon dioxide gas forms as the effervescing agents chemically combine when the nutrient composition is dissolved in an aqueous liquid within a hydroponic system The gas then bubbles up to the top surface of the liquid and is released to the plant tissues growing above and nearby. The plants grow faster and larger when using the effervescing compositions of this invention compared to using nutrient compositions that do not contain effervescing agents.

In an embodiment, the time-release compositions of this invention do not comprise a pair of effervescing agents.

Time-release agents known in the art and yet to be invented are useful in the practice of this invention, and include, but are not limited to Hydroxy Propyl Cellulose (HPC, Hercules Incorporated, Wilmington, Del.), Carbopols such as 981 and 71G (Noveon Inc., Cleveland, Ohio), PEGs such as 8000 and 20000 (Dow Chemical Company, Midland, Mich.).

### EXAMPLE 1

A tomato seed is placed in a hydroponics system. Two time-release, oxygen-generating plant nutrient compositions, each comprising about 0.01 grams calcium peroxide and about 1.25 grams of plant nutrients having the ingredients listed in table 1 inside a 00E1 veggie cap (Capsugel, Greenwood, S.C. USA), are added to 1 gallon of water in the hydroponics system. The time-release, oxygen-generating plant nutrient compositions completely dissolve and release the active ingredients in about one hour. Oxygen gas is generated in the water and the dissolved oxygen concentration is increased. Photoradiation is delivered to the seed for 16 hours -each day. A week passes. The tomato seed germinates. After 2 weeks, water is added to total one gallon, and two more of the time-release, oxygen-generating plant nutrient compositions, are added to the aqueous solution in the hydroponics system. The time-release, oxygen-generating plant nutrient compositions completely dissolve and release the active ingredients in about one hour. Oxygen gas is generated in the water and the dissolved oxygen concentration is increased. Water is added to the hydroponics system weekly. The tomato plant grows. At the end of week 4, two more time-release, oxygen-generating plant nutrient compositions are added to the 1 gallon of aqueous solution in the hydroponics system. A third time-release, oxygen-generating plant nutrient composition comprising about 0.01 grams calcium peroxide and about 1 gram of magnesium sulfate in a veggie cap is added. A fourth time-release, oxygen-generating plant nutrient composition comprising about 0.01 grams calcium peroxide and about 0.75 grams of calcium nitrate in a veggie cap is added. The time-release, oxygen-generating plant nutrient compositions completely dissolve and release the active ingredients in about one hour. The tomato plant grows and blooms. Water is added to the hydroponics system as needed. The same combination of four time-release, oxygen-generating plant nutrient compositions are added every two weeks. Tomatoes are produced and harvested.

### EXAMPLE 2

A basil seed was placed in a hydroponics system containing about 1 gallon of water. Two time-release plant nutrient compositions, each comprising about 1.25 grams of plant nutrients having the ingredients listed in table 1 inside a 00E1 veggie cap (Capsugel, Greenwood, S.C. USA), were added to the 1 gallon of water in the hydroponics system. The time-release plant nutrient compositions completely dissolved and released the active ingredients in about one hour. Photoradiation was delivered to the seed for 16 hours each day. A week passes. The basil seed germinated. Photoradiation continued to be delivered to the basil plant for 16 hours each day. After 2 weeks, water was added to the hydroponics system to total one gallon, and two more of the time-release plant nutrient compositions, were added to the aqueous solution in the hydroponics system. The time-release plant nutrient compositions completely dissolved and released the active ingredients in about one hour. Water was added to the hydroponics system weekly. The basil plant grew. At the end of week 4, two more time-release plant nutrient compositions were added to the 1 gallon of aqueous solution in the hydroponics system. A third time-release plant nutrient composition comprising about 1 gram of magnesium sulfate in a veggie cap was added. A fourth time-release plant nutrient composition comprising about 0.75 grams of calcium nitrate in a veggie cap was added. All four time-release plant nutrient compositions completely dissolved and released the active ingredients in about one hour. The basil plant grew. Water was added to the hydroponics system as needed. The same combination of four time-release plant nutrient compositions were added every two weeks. Basil leaves were produced and harvested to make pesto.

### EXAMPLE 3

Three compositions of this invention are made, the first containing 1.15 g of Hobby plant nutrients, the second containing 1 g of magnesium sulfate, and the third containing 0.75 calcium nitrate. In a hydroponics system, two of the Hobby plant nutrient compositions of this invention, are added to the water for germination. For lettuce, after two weeks, one of the Hobby compositions is added per gallon of water. For herbs, tomatoes, and flowers, one of the Hobby compositions, one of the calcium nitrate compositions, and one of the magnesium sulfate compositions are added every week.

### EXAMPLE 4

Two time-release compositions of this invention are made. The first, composition A, contains 1.5 grams of Hobby plant nutrients and 3% by weight PEG 8000 (0.045 g, Dow Chemical Company, Midland, Mich.) that is compressed at about 7 tons to make a tablet. The second, composition B, contains about 3 grams Hobby plant nutrients and 3% by weight PEG 8000 (0.09 g, Dow Chemical Company, Midland, Mich.) that is compressed at about 7 tons to make a tablet. The PEG 8000 and the compression both function as time-release agents. Seeds are started in a 14-cup containing hydroponic garden. The regimes for each type of seed are shown below in Table 2:

TABLE 2

| Seed Type | Start | Week 2 | Week 4 | Week 6 | Week 8 |
|---|---|---|---|---|---|
| Lettuce | 1A | 1A | 1A | 1A | 1A |
| Tomato | 1A | 1B | 1B | 1B | 1B |
| Herbs | 1A | 1A | 1B | 1B | 1B |
| Flowers | 1A | 1A | 1B | 1B | 1B |

Using these compositions and regimes, seeds germinate at a high rate and plants grow vigorously.

This invention provides a kit comprising a device of this invention and instructions for using the device.

Although this invention has been described with respect to specific embodiments, it is not intended to be limited thereto, and various modifications which will become apparent to the person of ordinary skill in the art are intended to fall within the scope of the invention as described herein. The embodiments of this invention are useful individually and in combination.

All references cited are incorporated herein by reference to the extent that they are not inconsistent with the disclosure herein.

1. A time-release plant nutrient composition comprising a complete set of plant nutrient ingredients and at least one time-release agent.

2. The time-release plant nutrient composition of claim 1 that has been compressed into a tablet, pellet, or granule.

3. The time-release plant nutrient composition of claim 1 further comprising an oxygen-generating agent and/or a pair of effervescing agents.

4. An oxygen-generating plant nutrient composition comprising: at least one oxygen-generating agent and at least one plant nutrient ingredient.

5. The oxygen-generating plant nutrient composition of claim 4 wherein said oxygen-generating agent is selected from the group consisting of peroxides, percarboxylics, percarbonates, and mixtures thereof.

6. The oxygen-generating plant nutrient composition of claim 5 wherein said peroxide is not hydrogen peroxide.

7. The oxygen-generating plant nutrient composition of claim 5 wherein said peroxide is selected from the group consisting of: sodium peroxide, potassium peroxide, magnesium peroxide, calcium peroxide, strontium peroxide, and mixtures thereof.

8. The oxygen-generating plant nutrient composition of claim 5 wherein said percarbonate is selected from the group consisting of sodium percarbonate, potassium percarbonate, and mixtures thereof.

9. The oxygen-generating plant nutrient composition of claim 4 wherein said oxygen-generating agent is in an amount selected from the group consisting of: less than about 10% by weight, less than about 5% by weight, less than about 2% by weight, less then amount 1% by weight, and less than 0.5% by weight.

10. The oxygen-generating plant nutrient composition of claim 4 that is useful for growing plants hydroponically.

11. The oxygen-generating plant nutrient composition of claim 10 wherein when said composition is placed in an aqueous solution useful in a hydroponics system, said at least one plant nutrient is released about completely during a time period selected from the group consisting of: between about 1 minute and about 1 month, between about 5 minutes and about 2 weeks, between about 1 week and about half an hour, between about 1 hour and about 48 hours, between about 2 hours and about 1 day, about 1 minute, about 5 minutes, about half an hour, about 1 hour, about 2 hours, about 6 hours, about 12 hours, about 24 hours, about 48 hours, about 1 week, and about 2 weeks.

12. The oxygen-generating plant nutrient composition of claim 4 comprising a complete set of plant nutrients.

13. The oxygen-generating plant nutrient composition of claim 4 further comprising a time-release agent and/or a pair of effervescing agents.

14. A method for providing oxygen to a plant growing or a seed germinating in a hydroponics system containing an aqueous liquid, said method comprising adding the oxygen-generating plant nutrient composition of claim 4 to said aqueous liquid.

15. An effervescing plant nutrient composition comprising a complete set of plant nutrient ingredients and at least one pair of effervescing agents.

16. The effervescing plant nutrient composition of claim 13 wherein said pair of effervescing agents comprises an acid and a carbonate.

17. The effervescing plant nutrient composition of claim 16 wherein said acid is citric acid and said carbonate is selected from the group consisting of: sodium bicarbonate, sodium carbonate, potassium bicarbonate, potassium carbonate, and mixtures thereof.

18. The effervescing plant nutrient composition of claim 15 further comprising a time-release agent and/or an oxygen-generating agent.

19. A method for providing a complete set of plant nutrients to a plant growing or a seed germinating in a hydroponics system containing an aqueous liquid, said method comprising adding the time-release plant nutrient composition of claim 1 to said aqueous liquid.

20. A method for providing oxygen to a plant growing or a seed germinating in a hydroponics system containing an aqueous liquid, said method comprising adding the oxygen-generating plant nutrient composition of claim 4 to said aqueous liquid.
